(19) United States
(12) Patent Application Publication
(10) Pub. No.: US 2025/0247296 A1
(43) Pub. Date: Jul. 31, 2025

(54) METHODS AND APPARATUSES FOR DETECTING AND RESOLVING CONFLICT IN A MOBILE COMMUNICATIONS NETWORK

(71) Applicant: Lenovo (Singapore) Pte. Limited, Singapore (SG)

(72) Inventors: Ishan Vaishnavi, München (DE); Dimitrios Karampatsis, Ruislip (GB)

(73) Assignee: Lenovo (Singapore) Pte. Limited, Singapore (SG)

(21) Appl. No.: 18/992,658

(22) PCT Filed: Aug. 24, 2022
(86) PCT No.: PCT/EP2022/073564

§ 371 Date: Jan. 9, 2025

(30) Foreign Application Priority Data
Jul. 12, 2022 (GR) 20220100551

(51) Int. Cl. H04L 41/0873; H04L 41/0859; H04L 41/5025; H04L 41/5054; H04W 24/02

(52) U.S. Cl. CPC H04L 41/0873; H04L 41/0863; H04L 41/5025; H04L 41/5054; H04W 24/02

(57) ABSTRACT

A coordination entity of a mobile network comprising one or more processors arranged to receive an indication that a first action of a first network function of the mobile network is in conflict with a second action of a second network function of the mobile network. The one or more processors are further arranged to, responsive to receiving the indication, configure the first network function such that, when the first action has been, is being, or will be performed by the first network function, the first network function outputs a notification indicating that the first action has been, is being, or will be performed by the first network function.

### FIELD

The subject matter disclosed herein relates generally to the field of detecting and resolving conflict between entities in a mobile communications network. This document defines a coordination entity of a mobile network, a network function of a mobile network, a method performed by a coordination entity of a mobile network, a further method performed by a coordination entity of a mobile network, and a method performed by a network function of a mobile network.

### BACKGROUND

5G has brought about a reduction in CAPEX with the introduction of virtualization, which has led to the use of commercial off-the-shelf (COTS) hardware. However, operators now need to manage the telco aspects as well as the virtualization aspects of the network. In addition, slicing has introduced the concept of different network slices each having their own characteristics and management requirements. This is expected to cause a rise in operating complexity of the network, in turn resulting in a rise in OPEX.

Since Release 16, 3GPP has defined Enablers for Network Automation for 5G, as part of the eNA work. The main objective of this work was to define methods and procedures to allow network functions (NFs) to receive statistical information and/or predictions on certain events which are used as basis to perform actions in order to optimise the network operation. A new network function was defined that provides analytics (in the form of statistics or predictions) to one or more NF(s) in the 5G core or to operations and management (OAM) platforms.

In Release 17, 3GPP enhanced the Network Automation work by defining a distributed network where multiple Network Data Analytic Functions (NWDAFs) can provide analytics information to one or more analytics consumer NFs.

In such a distributed approach, each NF decides on an action based on internal events, taking into account analytics provided by the NWDAF. The trigger for an NF to take an action and the action required is based on internal/vendor configuration which is implementation-specific and out of the scope of 3GPP. This may lead to inconsistent behaviour between NF(s) of the same type when taking decisions, taking into account analytic output from an NWDAF.

### SUMMARY

Disclosed herein are procedures for resolving conflict (e.g. resolving a conflict following a detection of that conflict) in a mobile communications network. Said procedures may be implemented by a coordination entity of a mobile network or a network function of a mobile network.

In a first aspect, there is provided a coordination entity of a mobile network. The coordination entity comprises one or more processors arranged to receive an indication that a first action of a first network function of the mobile network is in conflict with a second action of a second network function of the mobile network. The one or more processors are further arranged to, responsive to receiving the indication, configure the first network function such that, when the first action has been, is being, or will be performed by the first network function, the first network function outputs a notification indicating that the first action has been, is being, or will be performed by the first network function.

In a second aspect, there is provided a network function of a mobile network, the network function comprising one or more processors arranged to determine that a first action has been, is being, or will be performed by another network function of the mobile network. The one or more processors are further arranged to determine that the first action is in conflict with a second action, the second action being performable by the network function. The one or more processors are further arranged to, responsive to determining that the first action has been, is being, or will be performed by the another network function and determining that the first action is in conflict with the second action, disable performance of the second action by the network function.

In a third aspect, there is provided a method performed by a coordination entity of a mobile network. The method comprises receiving an indication that a first action of a first network function of the mobile network is in conflict with a second action of a second network function of the mobile network. The method further comprises, responsive to receiving the indication, configuring the first network function such that, when the first action has been, is being, or will be performed by the first network function, the first network function outputs a notification indicating that the first action has been, is being, or will be performed by the first network function.

In a fourth aspect, there is provided a further method performed by a coordination entity of a mobile network. The method comprises receiving an indication that a first action of a first network function of the mobile network is in conflict with a second action of a second network function of the mobile network. The method further comprises, responsive to receiving the indication, configuring the second network function such that the second network function disables its performance of the second action in response to the second network function being informed that the first action has been, is being, or will be performed by the first network function.

In a fifth aspect, there is provided a method performed by a network function of a mobile network. The method comprises determining that a first action has been, is being, or will be performed by another network function of the mobile network. The method further comprises determining that the first action is in conflict with a second action, the second action being performable by the network function. The method further comprises, responsive to determining that the first action has been, is being, or will be performed by the another network function and determining that the first action is in conflict with the second action, disabling performance of the second action by the network function.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for detecting and resolving conflict in a mobile communications network will now be described, by way of example only, with reference to the accompanying drawings, in which:

FIG. 1 is a schematic illustration depicting three types of actions that a network function can take in cases of conflict.

FIG. 2 is a schematic illustration of a known analytics architecture that enables network automation.

FIG. 3 is a schematic illustration of a known architecture for configuring actions to resolve conflicts between network functions.

FIG. 4 is a schematic illustration of a user equipment apparatus that may be used for implementing the methods described herein.

FIG. 5 is a schematic illustration of a network node that may be used for implementing the methods described herein.

FIG. 6 is a schematic illustration depicting an architecture in which a conflict management entity detects a conflict.

FIG. 7 depicts a procedure performed in the architecture for detecting and resolving or avoiding conflict between network functions.

FIG. 8 is a process flow chart depicting steps of a method performed by a coordination entity of a mobile network, for detecting and resolving or avoiding conflicts between network functions in the mobile network.

FIG. 9 is a process flow chart depicting steps of a further method performed by a coordination entity of a mobile network, for detecting and resolving or avoiding conflicts between network functions in the mobile network.

FIG. 10 is a process flow chart depicting steps of a yet further method performed by a network function of a mobile network, for detecting and resolving or avoiding conflict with another network function in the mobile network.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

In embodiments described herein, two NFs are considered to be conflicting when they behave in an uncoordinated manner, resulting in a sub-optimal network behaviour. Sub-optimal network behaviour may be defined as behaviour of the network which is not commensurate or proportional with, or which is characteristic of a performance significantly worse than, an expected or desired behaviour or performance, given the resources reserved to support said behaviour or performance.

Different NFs may respond to the output from a NWDAF with their individual actions. Similarly, different management service consumers may issue different provisioning requests to the managed entities, particularly as part of closed loops in the management planes. There are at least three cases of conflict possible. In a first case, the changes to managed entities may conflict within the management plane. In a second case, the actions of NFs based on the NWDAF output may conflict with each other within the control plane. In a third case, the changes in the management plane may conflict with the actions in the control plane.

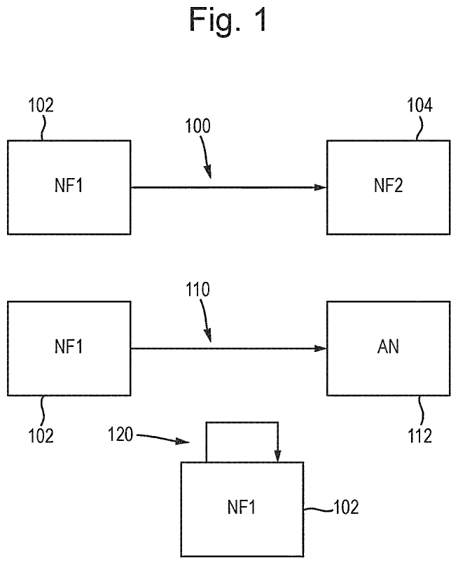

FIG. 1 is a schematic illustration depicting three types of actions that a NF can take in such cases of conflict.

In a first case 100, a first NF 102 of an analytics architecture signals changes to a second NF 104 of the analytics architecture, thereby to affect the way in which the second NF 104 functions. For example, a Plane Control Function (PCF) may provide Quality of Service (QOS) policies to the Session Management Function (SMF) that triggers the SMF to modify Protocol Data Unit (PDU) sessions and configure a User Plane Function (UPF) with appropriate traffic detection rules. In another example, a User Defined Route (UDR) provides updated subscription information to the PCF 106 that triggers the PCF 106 to provide new UE Route Selection Policy (URSP) rules.

In a second case 110, the first NF 102 signals changes in entities in an access network (AN) 112 that affects the way the AN 112 behaves. For example, the PCF may provide QoS policies to the SMF that triggers the SMF to modify the PDU sessions, and configure the AN 112 with appropriate QoS flow information.

In a third case 120, the first NF 102 changes its own behaviour. For example, the PCF of the first NF 102 may select a different policy, e.g. URSP rule, as a default for a particular network slice instance.

There may be multiple triggers for the first NF 102 performing an action. For example, these may include one or more of: a UE being registered in the analytics architecture; a UE requesting a new session, e.g. a new PDU session; the first NF 102 receiving analytics from a respective NWDAF, or the first NF 102 being configured by a respective OAM.

One existing method to support coordination of actions is based on a method disclosed where, in order to have a network with more informed decisions based on analytics provided by NWDAF, a new function is introduced, a Network Automation Function (NAUF).

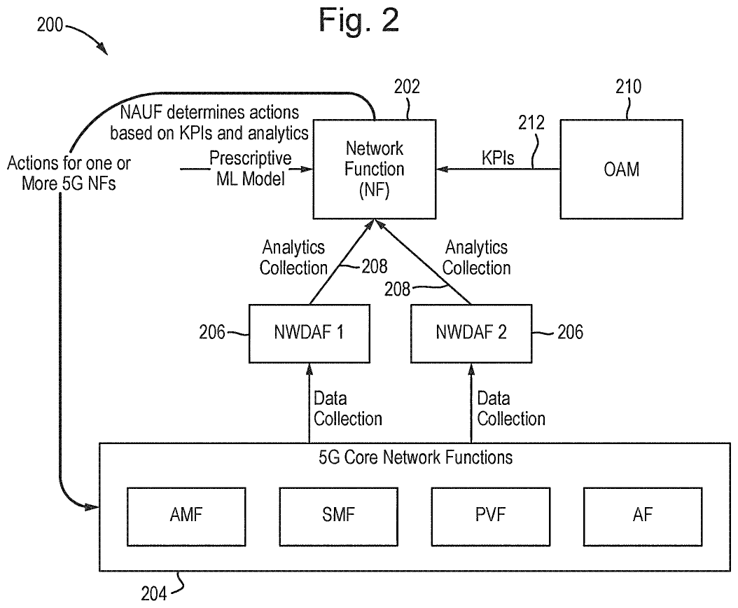

FIG. 2 illustrates such a known analytics architecture 200 that enables network automation. The solution proposed by the analytics architecture 200 is a method to support prescriptive analytics where a NF 202 (i.e., the NAUF) determines an action of one or more 5G core NFs 204 (e.g., the first NF 102 and/or the second NF 104) based on analytics received from one or more NWDAFs 206, as indicated by single-headed arrows and the reference numeral 208 in FIG. 2.

The NF 202 receives a plurality of analytics (e.g., multiple analytic IDs) from the one or more NWDAFs 206 and determines the actions that should be taken by the one or more NFs 204, in order to meet KPIs configured by an OAM 210, as indicated by a single-headed arrow and the reference numeral 212 in FIG. 2.

The analytics architecture 200 supports a method for prescriptive analytics where the NF 202, based on analytics received from one or more NWDAFs, determines actions of one or more 5G core NFs.

The closed loops in the management plane may be required to coordinate with closed loops in the control plane.

Table 1 presented below provides a brief description of the existing art.

| Source/publication date | Title | Description |
|---|---|---|
| 3GPP TS 28.536 v16.3.0 | Management services for | Annex A presents |
| | communication service | a high-level view |
| | assurance; Stage 2 and | of closed loop |
| | Stage 3. | from management. |

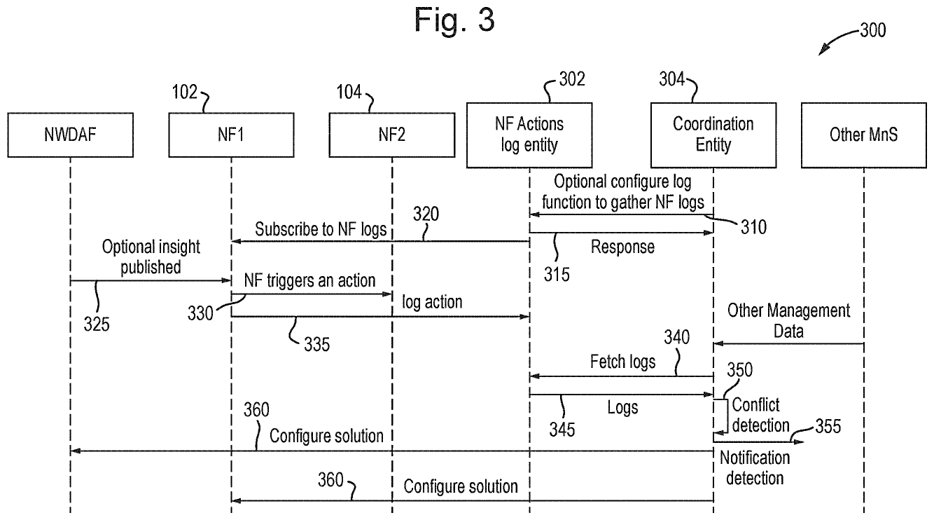

Another existing method for solving the issue is illustrated in FIG. 3. The method implements an entity that records, i.e. logs, actions of the NFs. These logs can then be used by a coordination or analytics entity to detect conflicts.

FIG. 3 is a schematic illustration depicting a known architecture 300 for configuring actions to resolve conflicts between NFs, e.g. the first NF 102 and the second NF 104, and configuring a log for recording actions taken by one or more such NFs, such as those described above.

The architecture 300 comprises a NF actions log entity 302 which records all such actions. The record, i.e. log, maintained by the NF actions log entity 302 can then be used by a coordination entity 304 to detect conflicts. The coordination entity 304 may be considered an analytics entity 304.

The coordination entity 304 requests the NF actions log entity 302 with the logs that the coordination entity 304 requires. This request may instruct the NF actions log entity 302 to filter which actions to provide based on, for example: a specific NF instance or a specific group of NFs; a (list of) specific analytic ID(s) of which the NF is a consumer; a specific geographic area (i.e. a NF serving a geographical area may be configured to report an action when the action corresponds to or is associated with said specific geographical area, or some other specific geographical area); a specific slice (i.e. only those NFs serving a certain network slice may be configured to report an action, e.g. in cases where NFs belong to a specific slice instance, or where actions affect network entities in a specific slice instance); or another possible filter.

Configuration by the coordination entity 304 of the NF actions log entity 302 with the logs which it should record/maintain is indicated in FIG. 3 with a single-headed arrow and the reference numeral 310.

The NF actions log entity 302 may respond to the coordination entity 304, for example with a confirmation that configuration was successful and/or that a configuration request was received. Response by the NF actions log entity 302 to the coordination entity 304 is indicated in FIG. 3 with a single-headed arrow and the reference numeral 315.

The NF actions log entity 302 subscribes to notifications of actions taken by the appropriate NFs and/or to notifications of communications in the communication channel between the NFs (not shown in FIG. 3). Filters similar to those described above with reference to the configuration 310 may be specified. For example, the NF actions log entity 302 may request a log of all actions relating to a particular NWDAF insight.

Subscription by the NF actions log entity 302 to notifications is indicated in FIG. 3 with a single-headed arrow and the reference numeral 320.

In this embodiment, the NWDAF publishes an insight in response to which the first NF 102 is required to log any actions which it takes. Publication by the NWDAF of the insight is indicated in FIG. 3 with a single-headed arrow and the reference numeral 325.

The first NF 102 may take, or trigger, an action in response to the published NWDAF insight. Such action is indicated in FIG. 3 with a single-headed arrow and the reference numeral 330, thereby to illustrate an action taken by the first NF 102 on or with respect to the second NF 104. However, such action may alternatively be another action taken by the first NF 102 or another NF, such as any of the actions illustrated in, and described above with reference to, FIG. 1. For example, the action may include a Network Slice Selection Function (NSSF) creating a new slice based on a slice load insight published by the NWDAF. The action 330 is logged at the actions log entity 302. The action logged could include one or more of, for example: the action 330 executed, e.g. any action of a NF (e.g. an SMF modifying a session); the trigger for action, e.g. a received notification (e.g. an NWDAF insight/analytics estimation); relevant network elements and/or their identifiers; a previous session and/or a value identifying the session; or a time at which the action was executed.

Logging of an action in the NF actions log entity 302 is indicated in FIG. 3 with a single-headed arrow and the reference numeral 335.

At some time instant, the coordination entity 304 may fetch some or all of the logs from the NF actions log entity 302. Filters similar to those described above with reference to the configuration 310 may be specified.

A request by the coordination entity 304 to fetch some or all of the logs from the NF actions log entity 302 is indicated in FIG. 3 with a single-headed arrow and the reference numeral 340.

A response to the request 340, which may include the logs, is provided by the NF actions log entity 302 to the coordination entity 304. The response provided by the NF actions log entity 302 to the coordination entity 304 is indicated in FIG. 3 with a single-headed arrow and the reference numeral 345.

The coordination entity 304 may also receive other performance information from another management service in the management plane, e.g. the OAM 210.

The coordination entity 304 (or another entity) performs conflict detection to detect possible conflicts. Conflicts are specifically defined as, for example, one or more of: the triggering or execution of contradictory actions (e.g. two different entities that signal changes to the other entities to achieve conflicting goals); changes to entities that result in a sub-optimal network behaviour (e.g. multiple entities responding to a NWDAF output performing various actions, at least some of which may be unnecessary for optimal or acceptable network behaviour); oscillating states that repeat themselves in a loop, typically because a first action triggers a second action that in turn re-triggers the first action.

Conflict detection in the coordination entity 304 is indicated in FIG. 3 with a single-headed arrow and the reference numeral 350.

The coordination entity 304 (or another entity) may issue a conflict-detected notification, i.e. a notification indicative of a conflict having been detected. Any interested entity subscribed to this notification can then receive such a notification. Conflict-detected notification in the coordination entity 304 is indicated in FIG. 3 with a single-headed arrow and the reference numeral 355.

The coordination entity 304 (or another entity) may configure a solution, or solutions, that resolves the conflict situation in the network. Such solutions may include, for example, one or more of: prioritizing certain actions over others; disabling certain actions in response NWDAF insights; limiting NFs to actions taken on certain network slices; changing thresholds for the NWDAF notifications; changing the triggers; change the association of triggers to actions; or any other changes that resolve the conflict situation in the network. The configuring, by the coordination entity 304, of solutions may be considered one or more actions (e.g. rectifying actions or remedial actions) taken by the coordination entity 304, and is indicated in FIG. 3 with single-headed arrows and the reference numeral 360. Such solutions may be sent to and/or configured in, or by, one or both of a respective NF (e.g. the first NF 102 or the second NF 104) and a NWDAF.

A method for detecting conflicts by the architecture 300 has thus been established.

The first proposed solution supporting NF coordination, according to the network architecture 200 depicted in FIG. 2, requires a centralized entity to monitor and understand the entire network, which is not a scalable approach.

The second proposed solution involving recording relevant actions, according to the architecture 300, works after the fact of the conflict and is a solution for determining that a conflict exists, rather than resolving it.

The present disclosure presents a solution for resolving conflicts in a scalable manner.

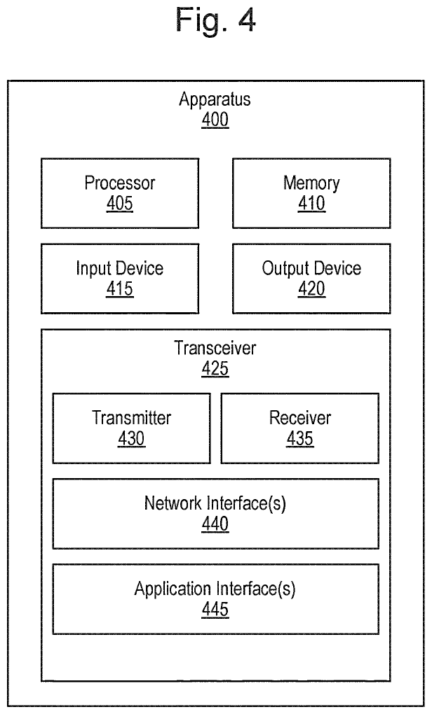

FIG. 4 depicts a user equipment apparatus (UE) 400 that may be used for implementing the methods described herein. The UE 400 is used to implement one or more of the solutions described below. The UE 400 includes a processor 405, a memory 410, an input device 415, an output device 420, and a transceiver 425.

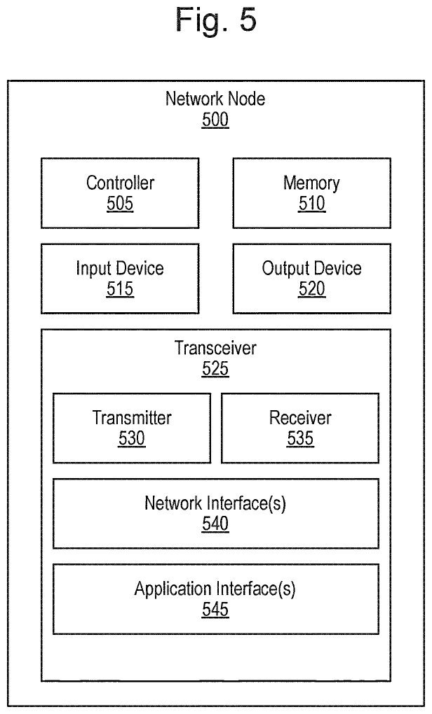

The UE 400 is in accordance with one or more of the NFs in the analysis architecture 100, and the NFs described in detail below, e.g. the first NF, the second NF, the one or more NWDAFs, etc., may comprise one or more of the components of the UE 400. For example, in some embodiments, one or more of the NFs described in detail below may comprise all of the components of the exemplary UE 400 described herein with reference to FIG. 5. In other embodiments, one or more of the NFs described in detail below may comprise only some of the components of the exemplary UE 400.

The input device 415 and the output device 420 may be combined into a single device, such as a touchscreen. In some implementations, the UE 400 does not include any input device 415 and/or output device 420. The UE 400 may include one or more of: the processor 405, the memory 410, and the transceiver 425, and may not include the input device 415 and/or the output device 420.

As depicted, the transceiver 425 includes at least one transmitter 430 and at least one receiver 435. The transceiver 425 may communicate with one or more cells (or wireless coverage areas) supported by one or more base units. The transceiver 425 may be operable on unlicensed spectrum. Moreover, the transceiver 425 may include multiple UE panels supporting one or more beams. Additionally, the transceiver 425 may support at least one network interface 440 and/or application interface 445. The application interface(s) 445 may support one or more APIs. The network interface(s) 440 may support 3GPP reference points, such as Uu, N1, PC5, etc. Other network interfaces 440 may be supported, as understood by one of ordinary skill in the art.

The processor 405 may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), or similar programmable controller. The processor 405 may execute instructions stored in the memory 410 to perform the methods and routines described herein. The processor 405 is communicatively coupled to the memory 410, the input device 415, the output device 420, and the transceiver 425.

The processor 405 may control the UE 400 to implement the UE behaviors described herein. The processor 405 may include an application processor (also known as “main processor”) which manages application-domain and operating system (“OS”) functions and a baseband processor (also known as “baseband radio processor”) which manages radio functions.

The memory 410 may be a computer readable storage medium. The memory 410 may include volatile computer storage media. For example, the memory 410 may include a RAM, including dynamic RAM (“DRAM”), synchronous dynamic RAM (“SDRAM”), and/or static RAM (“SRAM”). The memory 410 may include non-volatile computer storage media. For example, the memory 410 may include a hard disk drive, a flash memory, or any other suitable non-volatile computer storage device. The memory 410 may include both volatile and non-volatile computer storage media.

The memory 410 may store data related to implementing a traffic category field. The memory 410 may also store program code and related data, such as an operating system or other controller algorithms operating on the UE 400.

The input device 415 may include any known computer input device including a touch panel, a button, a keyboard, a stylus, a microphone, or the like. The input device 415 may be integrated with the output device 420, for example, as a touchscreen or similar touch-sensitive display. The input device 415 may include a touchscreen such that text may be input using a virtual keyboard displayed on the touchscreen and/or by handwriting on the touchscreen. The input device 415 may include two or more different devices, such as a keyboard and a touch panel.

The output device 420 may be designed to output visual, audible, and/or haptic signals. The output device 420 may include an electronically controllable display or display device capable of outputting visual data to a user. For example, the output device 420 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 420 may include a wearable display separate from, but communicatively coupled to, the rest of the UE 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

The output device 420 may include one or more speakers for producing sound. For example, the output device 420 may produce an audible alert or notification (e.g., a beep or chime). The output device 420 may include one or more haptic devices for producing vibrations, motion, or other haptic feedback. All, or portions, of the output device 420 may be integrated with the input device 415. For example, the input device 215 and output device 420 may form a touchscreen or similar touch-sensitive display. The output device 420 may be located near the input device 415.

The transceiver 425 communicates with one or more network functions of a mobile communication network via one or more access networks. The transceiver 425 operates under the control of the processor 405 to transmit messages, data, and other signals and also to receive messages, data, and other signals. For example, the processor 405 may selectively activate the transceiver 425 (or portions thereof) at particular times in order to send and receive messages.

The transceiver 425 includes at least one transmitter 430 and at least one receiver 435. The one or more transmitters 430 may be used to provide uplink (UL) communication signals to a base unit of a wireless communications network. Similarly, the one or more receivers 435 may be used to receive downlink (DL) communication signals from the base unit. Although only one transmitter 430 and one receiver 435 are illustrated, the UE 400 may have any suitable number of transmitters 430 and receivers 435. Further, the transmitter(s) 430 and the receiver(s) 435 may be any suitable type of transmitters and receivers. The transceiver 425 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

One or more transmitters 430 and/or one or more receivers 435 may be implemented and/or integrated into a single hardware component, such as a multi-transceiver chip, a system-on-a-chip, an Application-Specific Integrated Circuit (“ASIC”), or other type of hardware component. One or more transmitters 430 and/or one or more receivers 435 may be implemented and/or integrated into a multi-chip module. Other components such as the network interface 440 or other hardware components/circuits may be integrated with any number of transmitters 430 and/or receivers 435 into a single chip. The transmitters 430 and receivers 435 may be logically configured as a transceiver 425 that uses one more common control signals or as modular transmitters 430 and receivers 435 implemented in the same hardware chip or in a multi-chip module.

FIG. 5 depicts a network node 500 that may be used for implementing the methods described herein. The network node 500 may be one implementation of an entity in a wireless communications network. The network node 500 may be, for example, the UE 400 described above. The network node 500 includes a controller 505, a memory 510, an input device 515, an output device 520, and a transceiver 525.

The input device 515 and the output device 520 may be combined into a single device, such as a touchscreen. In some implementations, the network node 500 does not include any input device 515 and/or output device 520. The network node 500 may include one or more of: the controller 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more remote units 400. Additionally, the transceiver 525 may support at least one network interface 540 and/or application interface 545. The application interface(s) 545 may support one or more APIs. The network interface(s) 540 may support 3GPP reference points, such as Uu, N1, N2 and N3. Other network interfaces 540 may be supported, as understood by one of ordinary skill in the art.

The controller 505 may include any known controller capable of executing computer-readable instructions and/or capable of performing logical operations. For example, the controller 505 may be a microcontroller, a microprocessor, a CPU, a GPU, an auxiliary processing unit, a FPGA, or similar programmable controller. The controller 505 may execute instructions stored in the memory 510 to perform the methods and routines described herein. The controller 505 is communicatively coupled to the memory 510, the input device 515, the output device 520, and the transceiver 525.

The memory 510 may be a computer readable storage medium. The memory 510 may include volatile computer storage media. For example, the memory 510 may include a RAM, including dynamic RAM (“DRAM”), synchronous dynamic RAM (“SDRAM”), and/or static RAM (“SRAM”). The memory 510 may include non-volatile computer storage media. For example, the memory 510 may include a hard disk drive, a flash memory, or any other suitable non-volatile computer storage device. The memory 510 may include both volatile and non-volatile computer storage media.

The memory 510 may store data related to establishing a multipath unicast link and/or mobile operation. For example, the memory 510 may store parameters, configurations, resource assignments, policies, and the like, as described below. The memory 510 may also store program code and related data, such as an operating system or other controller algorithms operating on the network node 500.

The input device 515 may include any known computer input device including a touch panel, a button, a keyboard, a stylus, a microphone, or the like. The input device 515 may be integrated with the output device 520, for example, as a touchscreen or similar touch-sensitive display. The input device 515 may include a touchscreen such that text may be input using a virtual keyboard displayed on the touchscreen and/or by handwriting on the touchscreen. The input device 515 may include two or more different devices, such as a keyboard and a touch panel.

The output device 520 may be designed to output visual, audible, and/or haptic signals. The output device 520 may include an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the network node 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

The output device 520 may include one or more speakers for producing sound. For example, the output device 520 may produce an audible alert or notification (e.g., a beep or chime). The output device 520 may include one or more haptic devices for producing vibrations, motion, or other haptic feedback. All, or portions, of the output device 520 may be integrated with the input device 515. For example, the input device 515 and output device 520 may form a touchscreen or similar touch-sensitive display. The output device 520 may be located near the input device 515.

The transceiver 525 includes at least one transmitter 530 and at least one receiver 535. The one or more transmitters 530 may be used to communicate with the UE 400, as described herein. Similarly, the one or more receivers 535 may be used to communicate with network functions in the PLMN and/or RAN, as described herein. Although only one transmitter 530 and one receiver 535 are illustrated, the network node 500 may have any suitable number of transmitters 530 and receivers 535. Further, the transmitter(s) 530 and the receiver(s) 535 may be any suitable type of transmitters and receivers.

With reference again to FIG. 1, when a conflict management entity (e.g., in an OAM) receives a notification of detection of a conflict, it can decide that action of the first NF 102 has priority over action of the second NF 104. In that case, the conflict management can configure one of the conflicting NFs 102, 104 to publish the conflicting actions to a common conflict bus. The other of the NFs 102, 104 may subscribe to the conflict bus to listen for, i.e. await notification of, action of the first NF 102. When the second NF 104 detects action of the first NF 102, it does not execute action of the second NF 104 until a certain condition in the network is met. This condition could, for example, be a time duration, a threshold crossing, or another notification or any combination thereof. This condition may be configurable by the conflict management entity.

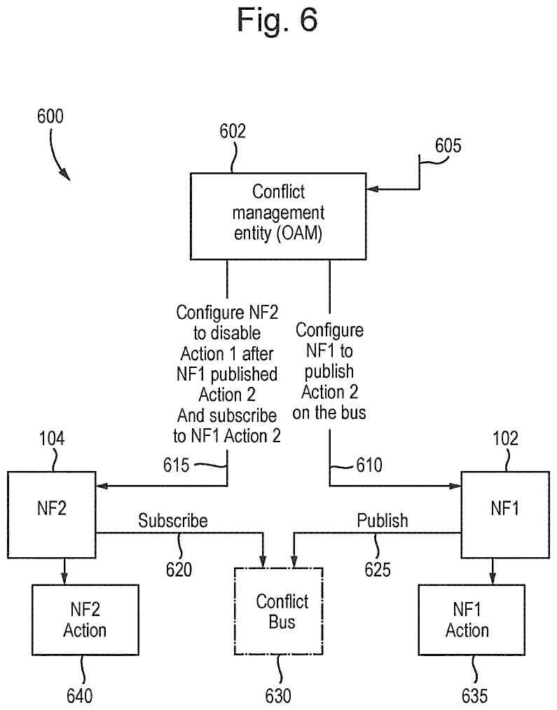

FIG. 6 depicts a high-level overview of an architecture 600 in which the conflict management entity 602 detects a conflict (indicated by a single-headed arrow and the reference numeral 605). Detection of the conflict by the conflict management entity 602 may comprise the conflict management entity 602 detecting the conflict itself, or receiving notification that a conflict has been detected from another, remote entity.

The conflict management entity 602 configures (indicated in FIG. 6 by a single-headed arrow and the reference numeral 610) the second NF 104 to disable the conflicting action of the second NF 104 when the second NF 104 receives a notification that the first NF 102 has, will or is about to execute an action of the first NF 102 that conflicts with the action of the second NF 104, and/or until some other condition is met (e.g. those outlined above). The conflict management entity 602 also configures (indicated in FIG. 6 by a single-headed arrow and the reference numeral 615) the second NF 104 to subscribe to notification by the first NF 102 that the action of the first NF 102 has been executed. As indicated by respective single-headed arrows and the reference numerals 620, 625, subscription by the second NF 104 to receive the notification of first NF 102 action and publication of notification of first NF 102 action may each be executed or performed via the conflict bus 630.

The conflict bus 630 allows communication of the first and second NFs 102, 104 such that respective actions 635, 640 of the first NF 102 and the second NF 104 are not performed in conflict.

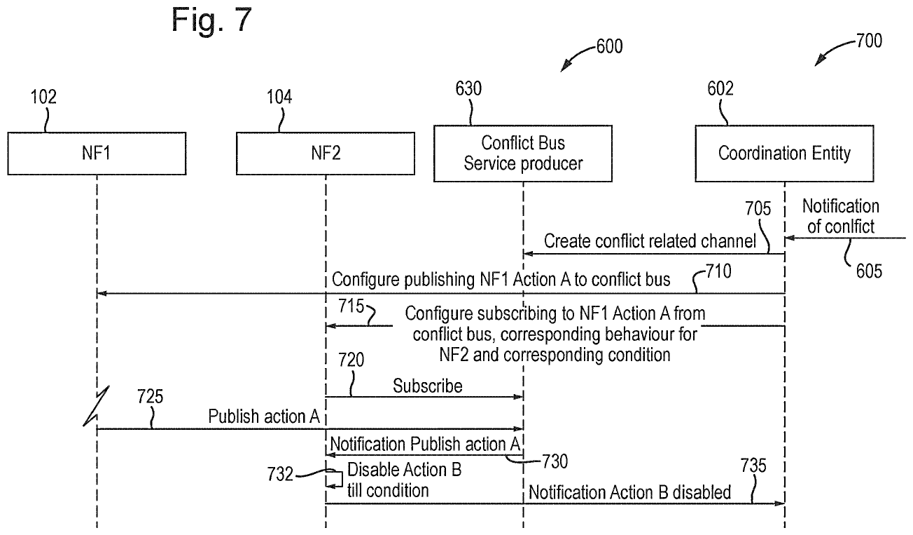

FIG. 7 depicts a procedure 700 performed in the architecture 600 for detecting and resolving or avoiding conflict between NFs.

The coordination entity 602 receives 605 a notification of conflict that specifies that possible a possible first action by the first NF 102 and a possible second action by the second NF 104 are conflicting. There may or may not be common events that cause this conflict. In the case of a common event, such as an analytics output (e.g. from a NWDAF) that causes the possible first and second actions to be in conflict, a common, e.g. resolving, action may be provided too. The coordination entity 602 may be any NF or management service producer, e.g. an OAM.

If the coordination entity 602 prioritises execution of action of the first NF 102 then the following steps are carried out.

The coordination entity 602 configures a channel in the conflict bus 630 relevant to the detected conflict. This is an optional step, and is indicated in FIG. 7 by a single-headed arrow and the reference numeral 705. This may typically involve creating a new broadcast channel that is relatable to the conflict detected. An existing channel may also be re-used for this purpose.

The coordination entity 602 configures (indicated in FIG. 7 by a single-headed arrow and the reference numeral 710) the first NF 102 to notify the conflict bus 630 with the configured/appropriate channel parameters if the first NF 102 has performed, is performing, or will be performing (e.g. is about to, or is preparing to execute) the action 635.

The coordination entity 602 configures (indicated in FIG. 7 by a single-headed arrow and the reference numeral 715) the second NF 104 to subscribe to receiving notification via the channel when the first NF 102 publishes the notification to the channel.

Alternatively, the first NF 102 may be configured, e.g. by the coordination entity 602, to directly inform the second NF 104 of the execution of the action 635. However, configuration via the conflict bus 630 allows for notification of multiple further NFs which may also be interested in being made aware of the first NF 102 having executed the action 635.

The second NF 104 subscribes (indicated in FIG. 7 by a single-headed arrow and the reference numeral 720) to the channel to receive notifications (e.g. notifications of execution of the action 635) by the first NF 102.

At some time in the future, for example when the action 635 is about to be, e.g. is being prepared to be, executed, the first NF 102 publishes (indicated in FIG. 7 by a single-head arrow and the reference numeral 725) the notification of the action 635 to the conflict bus 630.

A notification of conflict publication is sent to the second NF 104, as indicated in FIG. 7 by a single-headed arrow and the reference numeral 730.

In response to receiving the notification of conflict publication, the second NF 104 disables (indicated in FIG. 7 by a single-headed arrow and the reference numeral 732) execution of its (conflicting) action 640 until a condition stipulated in the configuration 715 of the second NF 104 carried out by the coordination entity 602 is met.

Subsequently, notification of the action 640 of the second NF 104 being disabled is sent to the coordination entity 602. In this embodiment, notification of the action 640 of the second NF 104 being, thereafter, enabled may also be sent to the coordination entity 602. Notification of the action 640 being disabled and/or notification of the action 640 being re-enabled being sent is indicated in FIG. 7 by a single-headed arrow and the reference numeral 735.

There is a chance that, in some cases, the first and second NFs 102, 104 execute their actions 635, 640 in such a manner and with such timing that the notification of execution of action 635 does not reach the second NF 104 in time to prevent its execution of the action 640, e.g. due to the delay in sending/receiving such a notification.

There may be multiple resolutions to this possible issue.

In a case in which the first NF 102 and the second NF 104 are responding to a common notification or trigger in a network, a response (e.g. the action 640) of the second NF 104 may be delayed by a period to account for decision by the first NF 102 to relay information to the second NF 104 in response to said common notification/trigger.

Additionally, or alternatively, the second NF 104 may be configured so as to always need to check with, i.e. obtain confirmation or permission from, the first NF 102 prior to the second NF 104 executing its action 640.

Additionally, or alternatively, the second NF 104 may be configured (e.g. by the coordination entity 602 or the first NF 102) to reverse, or roll back, undo, or otherwise reverse the effects of, the action 640 responsive to receiving the notification of execution of the action 635.

Thus, a procedure 700 is provided for detecting and resolving or avoiding conflicts between NFs in a network.

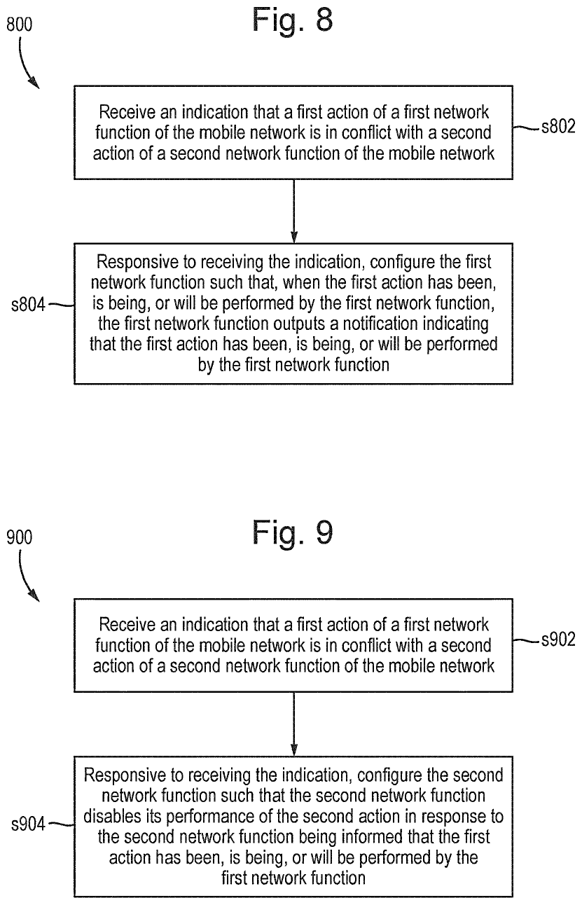

FIG. 8 is a process flow chart depicting steps of a method 800 performed by a coordination entity (e.g. the coordination entity 602) of a mobile network, for detecting and resolving or avoiding conflicts between NFs in the mobile network.

The method 800 comprises, at step s802, receiving an indication that a first action (e.g. the action 635) of a first NF (e.g. the first NF 102) of the mobile network is in conflict with a second action (e.g. the action 640) of a second NF (e.g. the second NF 104) of the mobile network.

The method 800 further comprises, at step s804, responsive to receiving the indication at step s802, configuring the first NF such that, when the first action has been, is being, or will be performed by the first NF, the first NF outputs a notification indicating that the first action has been, is being, or will be performed by the first NF.

Thus, there is provided a method 800 performed by a coordination entity of a mobile network, for detecting and resolving or avoiding conflicts between NFs in the mobile network.

FIG. 9 is a process flow chart depicting steps of a further method 900 performed by a coordination entity (e.g. the coordination entity 602) of a mobile network, for detecting and resolving or avoiding conflicts between NFs in the mobile network. The further method 900 may be performed by a given coordination entity in addition to or instead of the method 800.

The further method 900 comprises, at step s902, receiving an indication that a first action (e.g. the action 635) of a first NF (e.g. the first NF 102) of the mobile network is in conflict with a second action (e.g. the action 640) of a second NF (e.g. the second NF 104) of the mobile network.

The further method 900 further comprises, at step s904, responsive to receiving the indication at step s902, configuring the second NF such that the second NF disables its performance of the second action in response to the second NF being informed that the first action has been, is being, or will be performed by the first NF.

The second NF being informed that the first action has been, is being, or will be performed by the first NF may include, for example, the second NF receiving a notification indicating that the first action has been, is being, or will be performed by the first NF, such as the notification output by the first NF at step s804 of method 800.

Thus, there is provided a further method 900 performed by a coordination entity of a mobile network, for detecting and resolving or avoiding conflicts between NFs in the mobile network.

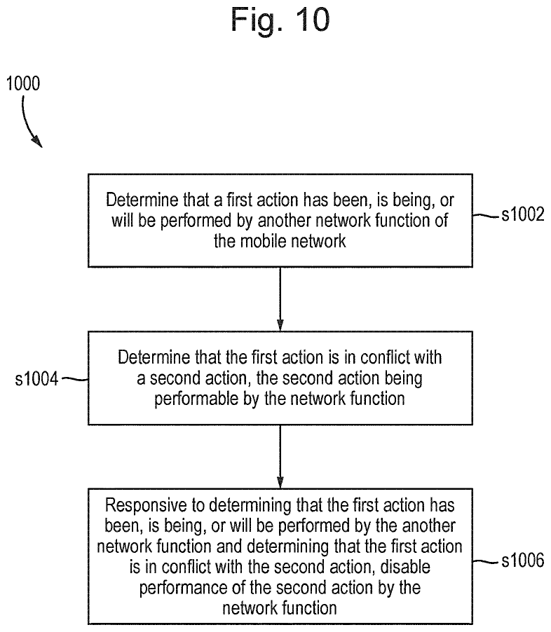

FIG. 10 is a process flow chart depicting steps of a method 1000 performed by a NF (e.g. the second NF 104) of a mobile network, for detecting and resolving or avoiding conflict with another NF in the mobile network.

The method 1000 comprises, at step s1002, determining that a first action (e.g. the action 635) has been, is being, or will be performed by another NF (e.g. the first NF 102) of the mobile network.

The NF being informed that the first action has been, is being, or will be performed by another NF may include, for example, the NF receiving a notification indicating that the first action has been, is being, or will be performed by another NF, such as the notification output by the first NF at step s804 of method 800.

The method 1000 further comprises, at step s1004, determining that the first action is in conflict with a second action, the second action being performable by the NF.

The method 1000 further comprises, at step s1006, responsive to determining that the first action has been, is being, or will be performed by the another NF (at step s1002) and determining that the first action is in conflict with the second action (at step s1004), disabling (e.g., temporarily or until one or more conditions are met) performance of the second action by the NF. In other words, the NF may disable its own performance of, or ability to perform, the second action.

Thus, there is provided a method 1000 performed by a NF of a mobile network, for detecting and resolving or avoiding conflicts with another NF in the mobile network.

In an embodiment, there is provided a coordination entity of a mobile network. The coordination entity may be in accordance with the coordination entity 602. The coordination entity is configured to perform the method 800.

In this embodiment, the coordination entity comprises one or more processors arranged to receive an indication that a first action of a first NF of the mobile network is in conflict with a second action of a second NF of the mobile network, i.e. to execute step s802 of the method 800.

In this embodiment, the one or more processors are further arranged to, responsive to receiving the indication, configure the first NF such that, when the first action has been, is being, or will be performed by the first NF, the first NF outputs a notification indicating that (respectively) the first action has been, is being, or will be performed by the first NF, i.e. to execute step s804 of the method 800.

In this embodiment, the one or more processors may be further arranged to, responsive to receiving the indication, configure the first NF and/or the second NF such that, when the first action has been, is being, or will be performed by the first network function, the second NF is informed that the first action has been, is being, or will be performed by the first NF.

In this embodiment, the one or more processors may be further arranged to, responsive to receiving the indication, configure a channel to receive the notification output by the first NF, the channel being in a kafka or communication bus (e.g. the conflict bus 630). The channel may be in an implementation of a kafka, publish-subscribe or communication bus. The communication bus may be a bus that both the first NF and the second NF are communicatively coupled to.

In this embodiment, the one or more processors may be further arranged to, responsive to receiving the indication, configure the first NF such that, when the first action has been, is being, or will be performed by the first NF, the first NF publishes, to the channel, the notification indicating that the first action has been, is being, or will be performed by the first NF.

In this embodiment, the one or more processors may be further arranged to, responsive to receiving the indication, configure the second NF to subscribe to receiving, from the channel, notifications that the first action has been, is being, or will be performed.

In this embodiment, the one or more processors may be further arranged to, responsive to receiving the indication, configure the first NF to, when the first action has been, is being, or will be performed by the first NF, directly notify the second NF that the first action has been, is being, or will be performed.

For example, the first NF may be configured with an address, such as an IP address, for the second NF. The second NF is preferably notified that the first NF has been configured with its address, for example by the coordination entity or the first NF. The first NF may use the address of the second NF to send a message to (directly notify) the second NF, the message indicating that the first action has been, is being, or will be performed by the first NF.

In this embodiment, the one or more processors may be further arranged to, responsive to receiving the indication, configure the second NF such that the second NF disables its own performance of the second action.

For example, the second NF may be configured such that it disables its own performance of the second action responsive to the second NF being informed that the first action has been, is being, or will be performed by the first network function, e.g. responsive to the second NF receiving the notification that the first action has been, is being, or will be performed.

The one or more processors may configure the second NF to disable its own performance of the second action based on one or more disabling conditions in the network. The one or more disabling conditions may include one or more disabling conditions selected from the list of disabling conditions consisting of: receipt of the notification that the first action has been, is being, or will be performed; receipt of a notification from another entity; receipt of an indication of a change in a key performance indicator occurring; and receipt of a notification from the network.

In this embodiment, the one or more processors may be further arranged to, responsive to receiving the indication, configure the second NF such that the second NF disables its own performance of the second action until one or more conditions are satisfied, e.g. responsive to the second NF being informed that the first action has been, is being, or will be performed by the first NF.

In this embodiment, the one or more processors may be further arranged to, responsive to receiving the indication, configure the second NF such that, responsive to the one or more conditions being satisfied, the second NF enables its performance of the second action.

In this embodiment, the one or more conditions may comprise one or more conditions selected from the group of conditions consisting of: a time period having elapsed; a change in a KPI occurring; and the second NF receiving, from an OAM of the mobile network, an instruction to enable performance of the second action by the second NF.

In this embodiment, the one or more processors may be further arranged to receive, from the second NF, a notification that performance of the second action by the second NF has been disabled. The one or more processors may be further arranged to receive, from the second NF, a notification that performance of the second action by the second NF has been enabled, e.g. responsive to performance of the second action being disabled and/or some other condition being met.

In this embodiment, the one or more processors are further arranged to, responsive to receiving the indication, configure the second NF to, prior to the second NF performing the second action, check with the first NF whether the first action has been, is being, or will be performed by the first NF.

For example, the second NF may perform this check by sending a message (e.g., a check message) to the first NF, e.g. using the first NF IP address. The first NF may respond to this (e.g., check) message with an indication as to whether the first action has been, is being, or will be performed.

In this embodiment, the one or more processors may be further arranged to, responsive to receiving the indication, configure the second NF to reverse, roll back, undo, or otherwise reverse the effects of the second action.

In this embodiment, the one or more processors may be further arranged to identify, to one of the first NF and the second NF, a trigger, the trigger being a common trigger for the first and second actions. The one or more processors may be further arranged to configure the one of the first NF and the second NF to apply a delay to the performance of its respective action when responding to the trigger.

For example, the delay period may be sufficient to account for the following: receipt of the notification by the first NF; processing of the notification by the first NF; issuing of the notification of the first action by the first NF; travel of the notification from the first NF to the second NF; and an additional margin, e.g. for network effects.

The trigger may be a trigger selected from the group of triggers consisting of: a time period having elapsed; a change in a key performance indicator occurring; and the second network function receiving from an operations and management system (OAM) of the mobile network, an instruction to enable performance of the second action by the second network function; or a notification from the network.

In another embodiment, there is provided a coordination entity of a mobile network. The coordination entity may be in accordance with the coordination entity 602. The coordination entity is configured to perform the method 900.

In this embodiment, the coordination entity comprises one or more processors arranged to receive an indication that a first action of a first NF of the mobile network is in conflict with a second action of a second NF of the mobile network, i.e. to execute step s902 of the method 900.

In this embodiment, the coordination entity is further arranged to, responsive to receiving the indication, configure the second NF such that the second NF disables its performance of the second action in response to the second NF being informed that the first action has been, is being, or will be performed by the first NF, i.e. to execute step s904 of the method 900.

In this embodiment, the one or more processors may be further arranged to receive, from the second NF, a notification that performance of the second action by the second NF has been disabled or enabled, e.g. responsive to performance of the second action being disabled/enabled by the second NF and/or some other condition being met.

The one or more processors may be further arranged to, responsive to receiving the indication, configure the second network function such that the second network function disables its own performance of the second action responsive to one or more disabling conditions being satisfied. The one or more disabling conditions may include one or more disabling conditions selected from the list of disabling conditions consisting of: receipt, by the second network function, of the notification that the first action has been, is being, or will be performed; receipt, by the second network function, of a notification from another entity; receipt, by the second network function, of an indication of a change in a key performance indicator occurring; and receipt, by the second network function, of a notification from the network.

In this embodiment, the one or more processors may be further arranged to, responsive to receiving the indication, configure the second NF such that the second NF disables its performance of the second action until one or more conditions are satisfied.

In this embodiment, the one or more processors may be further arranged to configure the second NF such that the second NF, responsive to the one or more conditions being satisfied, enables its performance of the second action.

In this embodiment, the one or more processors may be further arranged to receive, from the second NF, a notification that performance of the second action by the second NF has been enabled, e.g. responsive to performance of the second action or enabling of the second action.

In this embodiment, the one or more conditions may comprise one or more conditions selected from the group of conditions consisting of: a time period having elapsed; a change in a KPI occurring; and the second NF receiving, from an OAM of the mobile network, an instruction to enable performance of the second action by the second NF.

In another embodiment, there is provided a NF of a mobile network, the NF comprising one or more processors arranged to determine that a first action is performed by the first NF and (e.g., prior to performing the first action) inform a further NF that the first action will be performed.

In another embodiment, there is provided a NF of a mobile network, the NF comprising one or more processors arranged to determine that a first action is performed by the first NF and (e.g., prior to performing the first action) publish, to a channel in a bus (e.g. the conflict bus 630), a notification that the first action will be performed. The bus may be a bus to which both the first NF and the second NF are communicatively coupled.

In another embodiment, there is provided a NF of a mobile network. The NF may be in accordance with the second NF 104. The NF is configured to perform the method 1000.

In this embodiment, the NF comprises one or more processors arranged to determine that a first action has been, is being, or will be performed by another NF of the mobile network, i.e. execute step s1002 of the method 1000.

In this embodiment, the one or more processors are further arranged to determine that the first action is in conflict with a second action, the second action being performable by the NF, i.e. execute step s1004 of the method 1000.

In this embodiment, the one or more processors are further arranged to, responsive to determining that the first action has been, is being, or will be performed by the another network function (at step s1002) and determining that the first action is in conflict with the second action (at step s1004), disable (e.g., temporarily or until one or more conditions are met) performance of the second action by the NF, i.e. execute step s1006 of the method 1000.

In this embodiment, the one or more processors may be further arranged to configure the NF to subscribe to receiving, from a channel on a bus (e.g. the conflict bus 630), notifications that the first action has been, is being, or will be performed by the another NF.

In this embodiment, the one or more processors may be further arranged to configure the NF such that disablement of the second action is maintained (i.e. the second action remains disabled) until one or more conditions are satisfied, the one or more conditions comprising one or more conditions selected from the group of conditions consisting of: a time period having elapsed; a change in a KPI occurring; and the NF receiving, from an OAM of the mobile network, an instruction to enable performance of the second action by the NF.

In this embodiment, the one or more processors may be further arranged to, prior to the NF performing the second action, check with (e.g., confirm or query) the another NF as to whether the first action has been, is being, or will be performed by the another NF.

The one or more processors may be further arranged to disable the performance of the second action responsive to one or more disabling conditions being satisfied. The one or more disabling conditions may include one or more disabling conditions selected from the list of disabling conditions consisting of: receipt, by the second network function, of the notification that the first action has been, is being, or will be performed; receipt, by the second network function, of a notification from another entity; receipt, by the second network function, of an indication of a change in a key performance indicator occurring; and receipt, by the second network function, of a notification from the network.

With increasing complexity in networks, network automation has become a key requirement. Automation has however introduced/exacerbated the possibility of conflicts in the network. For example, when a NWDAF issues insights different NFs may take actions based on those insights, these actions potentially conflicting.

Advantageously, the current solution, as compared to previous work, introduces systems and methods to resolve conflicts between two or more NFs by configuring one NF to inform the other(s) of its execution of, or intention to execute, an action.

Advantageously, the methods and apparatuses described herein tend to prevent or mitigate the risk of inconsistent behaviour between NFs in a network, which might otherwise lead to undesirable operation of the network.

Advantageously, the methods and apparatuses described herein tend to facilitate coordination of actions of multiple NFs, including a number of NFs greater than two, e.g. via the conflict bus 630.

It should be noted that the above-mentioned methods and apparatuses illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatuses may be applied. For example, while specific examples have been given in the context of 3GPP, the principles disclosed herein can also be applied to another wireless communications system, and indeed any communications system which uses routing rules.

The method may also be embodied in a set of instructions, stored on a computer-readable medium, which when loaded into a computer processor, Digital Signal Processor (DSP) or similar, causes the processor to carry out the hereinbefore described methods.

The described methods and apparatuses may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A coordination entity for wireless communication, comprising:
at least one memory; and
at least one processor coupled with the at least one memory and configured to cause the coordination entity to:
receive an indication that a first action of a first network function of a mobile network is in conflict with a second action of a second network function of the mobile network; and
responsive to receiving the indication, configure the first network function to output a notification that indicates whether the first action has been, is being, or will be performed by the first network function.

2. The coordination entity of claim 1, wherein the at least one processor is configured to cause the coordination entity to, responsive to receiving the indication:
configure a channel to receive the notification output by the first network function, the channel including at least one of a publish-subscribe system or a communication bus; and
configure the first network function to publish to the channel, the notification indicating that the first action has been, is being, or will be performed by the first network function.

3. The coordination entity of claim 2, wherein the at least one processor is configured to cause the coordination entity to, responsive to receiving the indication, configure the second network function to subscribe to receiving, from the channel, notifications that the first action has been, is being, or will be performed.

4. The coordination entity of claim 1, wherein the at least one processor is configured to cause the coordination entity to, responsive to receiving the indication, configure the first network function to directly notify the second network function that the first action has been, is being, or will be performed by the first network function.

5. The coordination entity of claim 1, wherein the at least one processor is configured to cause the coordination entity to, responsive to receiving the indication, configure the second network function to disable performance of the second action based on one or more disabling conditions in the mobile network, the one or more disabling conditions including receipt, by the second network function, of one or more of:
the notification that the first action has been, is being, or will be performed;
a notification from another entity;
an indication of a change in a key performance indicator occurring; or
a notification from the mobile network.

6. The coordination entity of claim 5, wherein the at least one processor is configured to cause the coordination entity to, responsive to receiving the indication, configure the second network function, responsive to one or more enabling conditions being satisfied, to enable the performance of the second action, wherein the one or more enabling conditions include one or more of:
a time period having elapsed;
the change in the key performance indicator occurring;
the second network function receiving, from an operations and management system (OAM) of the mobile network, an instruction to enable the performance of the second action by the second network function; or
a notification configurable from the mobile network.

7. The coordination entity of claim 1, wherein the at least one processor is configured to cause the coordination entity to, responsive to receiving the indication, configure the second network function to, prior to the second network function performing the second action, check with the first network function whether the first action has been, is being, or will be performed by the first network function.

8. The coordination entity of claim 1, wherein the at least one processor is configured to cause the coordination entity to configure the second network function to, in response to receiving the indication, reverse effects of the second action.

9. The coordination entity of claim 1, wherein the at least one processor is configured to cause the coordination entity to:
identify, to one of the first network function or the second network function, a common trigger for the first action and the second action; and
configure the one of the first network function or the second network function to delay performance of one of the first action by the first network function responding to the trigger or the second action by the second network function responding to the trigger;
wherein the common trigger includes at least one of:
a time period having elapsed;
a change in a key performance indicator occurring;
the second network function receiving, from an operations and management system (OAM) of the mobile network, an instruction to enable the performance of the second action by the second network function; or
a notification from the mobile network.

10. A coordination entity for wireless communication, comprising:
at least one memory; and
at least one processor coupled with the at least one memory and configured to cause the coordination entity to:
receive an indication that a first action of a first network function of a mobile network is in conflict with a second action of a second network function of the mobile network; and
responsive to receiving the indication, configure the second network function to disable performance of the second action in response to the second network function being informed that the first action has been, is being, or will be performed by the first network function.

11. The coordination entity of claim 10, wherein the at least one processor is configured to cause the coordination entity to, responsive to receiving the indication, configure the second network function to disable the performance of the second action responsive to one or more disabling conditions being satisfied, the one or more disabling conditions including receipt, by the second network function, of one or more of:
a notification that the first action has been, is being, or will be performed;
a notification from another entity;
an indication of a change in a key performance indicator occurring; or
a notification from the mobile network.

12. The coordination entity of claim 11, wherein the at least one processor is configured to cause the coordination entity to configure the second network function to, responsive to one or more enabling conditions being satisfied, enable the performance of the second action.

13. The coordination entity of claim 12, wherein the one or more enabling conditions include at least one of:
a time period having elapsed;
the change in the key performance indicator occurring;
the second network function receiving, from an operations and management system (OAM) of the mobile network, an instruction to enable the performance of the second action by the second network function; or
a notification from the mobile network.

14-20. (canceled)

21. A processor for wireless communication, comprising:
at least one controller coupled with at least one memory and configured to cause the processor to:
receive an indication that a first action of a first network function of a mobile network is in conflict with a second action of a second network function of the mobile network; and
responsive to receiving the indication, configure the first network function to output a notification that indicates whether the first action has been, is being, or will be performed by the first network function.

22. The processor of claim 21, wherein the at least one controller is configured to cause the processor to, responsive to receiving the indication:
configure a channel to receive the notification output by the first network function, the channel including at least one of a publish-subscribe system or a communication bus; and
configure the first network function to publish to the channel, the notification indicating that the first action has been, is being, or will be performed by the first network function.

23. The processor of claim 22, wherein the at least one controller is configured to cause the processor to, responsive to receiving the indication, configure the second network function to subscribe to receiving, from the channel, notifications that the first action has been, is being, or will be performed.

24. The processor of claim 21, wherein the at least one controller is configured to cause the processor to, responsive to receiving the indication, configure the first network function to directly notify the second network function that the first action has been, is being, or will be performed by the first network function.

25. The processor of claim 21, wherein the at least one controller is configured to cause the processor to, responsive to receiving the indication, configure the second network function to disable performance of the second action based on one or more disabling conditions in the mobile network, the one or more disabling conditions including receipt, by the second network function, of one or more of:
the notification that the first action has been, is being, or will be performed;
a notification from another entity;
an indication of a change in a key performance indicator occurring; or
a notification from the mobile network.

26. The processor of claim 25, wherein the at least one controller is configured to cause the processor to, responsive to receiving the indication, configure the second network function, responsive to one or more enabling conditions being satisfied, to enable the performance of the second action, wherein the one or more enabling conditions include one or more of:
a time period having elapsed;
the change in the key performance indicator occurring;
the second network function receiving, from an operations and management system (OAM) of the mobile network, an instruction to enable the performance of the second action by the second network function; or
a notification configurable from the mobile network.

27. A processor for wireless communication, comprising:
at least one controller coupled with at least one memory and configured to cause the processor to:
receive an indication that a first action of a first network function of a mobile network is in conflict with a second action of a second network function of the mobile network; and
responsive to receiving the indication, configure the second network function to disable performance of the second action in response to the second network function being informed that the first action has been, is being, or will be performed by the first network function.
